(19) United States
(12) Patent Application Publication
(10) Pub. No.: US 2004/0023186 A1
(43) Pub. Date: Feb. 5, 2004

(54) Multi-tapered endodontic file

(76) Inventor: John T. McSpadden, Lookout Mountain, GA (US)

Correspondence Address: LAW OFFICES OF JONATHAN A. BARNEY, ESQ., 312 SIGNAL ROAD, SUITE 200, NEWPORT BEACH, CA, 92663, US

(21) Appl. No.: 10/440,040

(22) Filed: May 16, 2003

Related U.S. Application Data
(60) Provisional application No. 60/381,409, filed on May 16, 2002.

(51) Int. Cl. A61C 5/02

(52) U.S. Cl. 433/102

(57) ABSTRACT

A multi-tapered endodontic file is provided, formed from shaft of material having a generally twisted prismatic shape defined by three or more side surfaces and three or more interposed corners. The shaft includes a working portion having one or more tissue-removing edges, points and/or surfaces. The working portion is tapered along its length in accordance with a first predetermined taper function. The working portion is further tapered in accordance with second taper function different from the first taper function. The superimposition of the first and second taper functions results in a desired interference pattern of tissue-removing edges, points and/or surfaces. The multi-tapered endodontic file design exhibits increased efficacy, with less tendency to bind or screw into and/or break within the root canal.

### RELATED APPLICATIONS

This application claims priority under 35 U.S.C. § 119(e) to U.S. provisional application Ser. No. 60/381,409, filed May 16, 2002.

### BACKGROUND OF THE INVENTION

1. Field of the Invention

The present invention relates generally to the field of dentistry and more particularly to an endodontic instrument having multiple superimposed tapers for cleaning and enlarging a root canal.

2. Description of the Related Art

In the field of endodontics, one of the most important and delicate procedures is that of cleaning or extirpating a root canal to provide a properly dimensioned cavity while essentially maintaining the central axis of the canal. This step is important in order to enable complete filling of the canal without any voids and in a manner which prevents the entrapment of noxious tissue in the canal as the canal is being filled.

In a root canal procedure, the dentist removes inflamed tissue and debris from the canal prior to filling the canal with an inert filling material. In performing this procedure the dentist must gain access to the entire canal, shaping it as necessary. But root canals normally are very small in diameter, and they can often be quite curved. It is therefore very difficult to gain access to the full length of a root canal.

Many tools have been designed to perform the difficult task of cleaning and shaping root canals. Historically, dentists have used a wide multitude of tools to remove the soft and hard tissues of the root canal. These tools, usually called endodontic files, have been made by three basic processes. In one process, a file is created by twisting a prismatic rod of either square or triangular cross section in order to create a file with helical cutting/abrading edges (“K-file”). The second process involves grinding helical flutes into a circular or tapered rod to create a file with one or more helical cutting edges (“Hedstrom file”). The third method involves “hacking” or rapidly striking a circular or tapered rod with a blade at a given angle along the length of the rod, thus creating an endodontic file characterized by a plurality of burr-like barbs or cutting edge projections (“barbed file” or “broach”). Each of these instruments and manufacturing processes have unique advantages, and disadvantages.

A particularly problematic aspect of current state-of-the-art endodontic files, particularly K-files and Hedstrom files, is catastrophic failure caused by torque overload. Often, files will become lodged or jammed within the canal such that continued twisting or turning can cause the file to fail or break off in the canal. For endodontic files having twisting or helically spiraling cutting edges, such files can often unexpectedly engage or borough into the root canal, inadvertently driving the instrument deep into the root canal and possibly puncturing the apical seal thereof and/or otherwise transporting through the canal wall (so-called “screwing-in effect”). Another prevalent problem is heavy torque loading caused by inefficient cutting and/or high surface area engagement of the file with the inner canal wall. Excessive torque loading is problematic because it increases the friction heat generated within the canal per file revolution, increasing the chance of bone necrosis and/or catastrophic failure of the file/reamer instrument.

Accordingly, there is a need for an improved endodontic file design which overcomes these and other problems. SUMMARY OF THE INVENTION

It is therefore an object of the present invention to provide an improved endodontic file design having reduced torque loading and reduced tendency to screw in to the canal. It is another object of the invention to provide an endodontic instrument having a reduced tendency to break during use. It is another object of the invention to improve the efficacy of an endodontic instrument and/or to reduce the number of instruments necessary to enlarge a root canal.

According to one embodiment of the present invention, a multi-tapered endodontic file is provided, formed from shaft of material having a generally twisted or fluted prismatic shape defined by three or more side surfaces and three or more interposed corners. The shaft includes a working portion having one or more tissue-removing helical cutting edges. The working portion is tapered along its length in accordance with a first predetermined taper function. The working portion is further tapered in accordance with second taper function different from the first taper function. The superimposition of the first and second taper functions results in a desired interference pattern of the tissue-removing helical cutting edges. The multi-tapered endodontic file design exhibits increased efficacy, with less tendency to bind or screw into and/or break within the root canal.

According to another embodiment of the present invention, a multi-tapered endodontic instrument is provided for cleaning and extirpating a root canal. The instrument comprises an elongated shaft having a working portion having one or more tissue-removing edges, points and/or other tissue abrading surfaces thereon. The working portion is tapered along its length in accordance with a first predetermined taper function. The working portion is further tapered in accordance with second taper function different from said first taper function, whereby a desired interference pattern of tissue-removing edges, points and/or other surfaces is achieved.

According to another embodiment the present invention provides a method of manufacturing a multi-tapered endodontic instrument. An elongated generally prismatic rod of material is provided having a desired cross-section shape defined by three or more sides and sharp corners interposed therebetween. At least two or more of the sides of the rod are shaped or modulated in accordance with a predetermined taper function to create a multi-tapered rod of material. The multi-tapered rod is then twisted causing the sides and the corners of the rod to assume a helical or spiraling shape useful for shaping and extirpating a root canal. Endodontic files so-formed exhibit increased efficacy, have less tendency to bind and break within the root canal or screw into the root canal.

For purposes of summarizing the invention and the advantages achieved over the prior art, certain objects and advantages of the invention have been described herein above. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is a section view of a tooth and root structure illustrating the use of a typical endodontic instrument for performing a typical root canal procedure;

FIG. 2A is a side elevation view of a multi-tapered endodontic instrument having features and advantages of the present invention;

FIG. 2B is a top plan view of the fitting portion of the multi-tapered endodontic instrument of FIG. 2A;

FIG. 2C is a detail view of the working portion of the multi-tapered endodontic instrument of FIG. 2A having a first generally sinusoidal taper enveloped within a second substantially linear outer taper;

FIG. 2D is a partial cross-section view of the working portion of the multi-tapered endodontic instrument of FIG. 2A;

FIG. 3A is a side elevation view of an alternative embodiment of a multi-tapered endodontic instrument having features and advantages of the present invention;

FIG. 3B is a top plan view of the fitting portion of the multi-tapered endodontic instrument of FIG. 3A;

FIG. 3C is a detail view of the working portion of the multi-tapered endodontic instrument of FIG. 3A having a first generally helical taper enveloped within a second substantially linear outer taper;

FIG. 3D is a partial cross-section view of the working portion of the multi-tapered endodontic instrument of FIG. 3A;

FIGS. 4A-I are partial transverse cross-section views of additional alternative embodiments of a multi-tapered endodontic instrument having features and advantages of the present invention; and

FIGS. 5A-C are perspective views of multi-tapered rods suitable for forming multi-tapered K-files in accordance with one preferred embodiment of the invention.

### DETAILED DESCRIPTION OF THE PREFERRED EMBODIMENTS

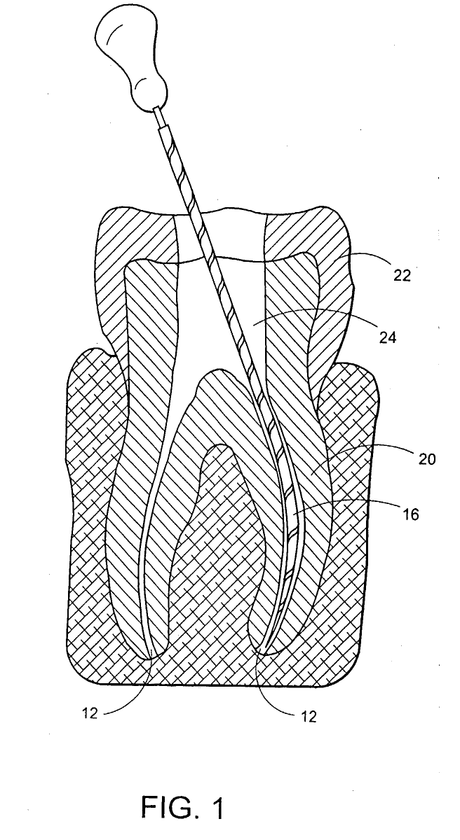

FIG. 1 is a partial cross section of a tooth 50 and supporting root structure illustrating the use of a typical fluted endodontic file 80 to carry out a standard root canal procedure. The root canal 56 of a tooth houses the circulatory and neural systems of the tooth. These enter the tooth at the terminus 52 of each of its roots 54 and extend through a narrow, tapered canal system to a pulp chamber 58 adjacent the crown portion 60 of the tooth. If this pulp tissue becomes diseased or injured, it can cause severe pain and trauma to the tooth, sometimes necessitating extraction of the tooth. Root canal therapy involves removing the diseased tissue from the canal 56 and sealing the canal system in its entirety. If successful, root canal therapy can effectively alleviate the pain and trauma associated with the tooth so that it need not be extracted.

To perform a root canal procedure, the endodontist first drills into the tooth 50 to locate the root canal(s) 56 and then uses an endodontic file or reamer instrument 80 to remove the decayed, injured or dead tissue from the canal. These instruments are typically elongated cutting or abrading instruments which are rotated and/or reciprocated within the root canal either by hand or using a slow speed drill. The primary goal is to remove all of the decayed or injured nerve while leaving the integrity of the root canal walls relatively unaffected. Preserving the integrity of the root canal 56 is important in order to allow proper filling of the root canal void in a homogenous three dimensional manner such that leakage or communication between the root canal system and the surrounding and supporting tissues of the tooth 50 is prevented. Once as much of the diseased material as practicable is removed from the root canal, the canal 56 is sealed closed, typically by reciprocating and/or rotating a condenser instrument in the canal to urge a sealing material such as gutta-percha into the canal.

One of the primary challenges in performing root canal therapy is that the root canals are not necessarily straight and are often curved or convoluted. Therefore, it is often difficult to clean the canal while preserving its natural shape. Many instruments (particularly the older, stainless steel instruments) have a tendency to straighten out the canal or to proceed straight into the root canal wall, altering the natural shape of the canal. In some extreme cases, the instrument may transport completely through the canal wall causing additional trauma to the tooth and/or surrounding tissues. Also, the openings of many root canals are small, particularly in older patients, due to calcified deposits on the root canal inner walls. Thus the files or reamers must be able to withstand the torsional load necessary to penetrate and enlarge the canal opening without breaking the instrument, as may also occasionally occur with the older stainless steel endodontic files.

To alleviate the transportation and breakage problems, highly flexible endodontic files fabricated from nickel-titanium alloy (Nitinol™ or NiTi) were introduced and have become widely accepted. See, e.g. U.S. Pat. No. 5,882,198, incorporated herein by reference. A series of comparative tests of endodontic instruments made of nickel-titanium alloy (Nitinol™ or NiTi) and stainless steel were conducted and published in an article entitled “An Initial Investigation of the Bending and the Torsional Properties of Nitinol Root Canal Files,” Journal of Endodontics, Volume 14, No. 7, July 1988, pages 346-351. The reported tests demonstrated that the NiTi instruments exhibited superior flexibility and torsional properties as compared to stainless steel instruments.

In general, alloys of nickel (Ni) and titanium (Ti) have a relatively low modulus of elasticity (0.83 GPa) over a wide range, a relatively high yield strength (0.195-690 MPa), and the unique and the unusual property of being “superelastic” over a limited temperature range. Superelasticity refers to the highly exaggerated elasticity, or spring-back, observed in many NiTi and other superelastic alloys over a limited temperature range. Such alloys can deliver over 15 times the elastic motion of a spring steel, i.e., withstand twisting or bending up to 15 times greater without permanent deformation. The particular physical and other properties of Nitinol alloys may be varied over a wide range by adjusting the precise Ni/Ti ratio used.

Conventional fluted instruments 80 (even those fabricated of NiTi) also suffer from an occasional tendency to bind and/or to advance unpredictably into the root canal 56 by virtue of a “screwing-in” effect as the instrument is rotated. In many cases, this binding or screwing-in effect can result in the file breaking inside the canal. In the most severe cases, the fluted instrument 80 can actually drive itself through the terminus of the canal 56 and into the patient's jaw bone and surrounding soft tissues.

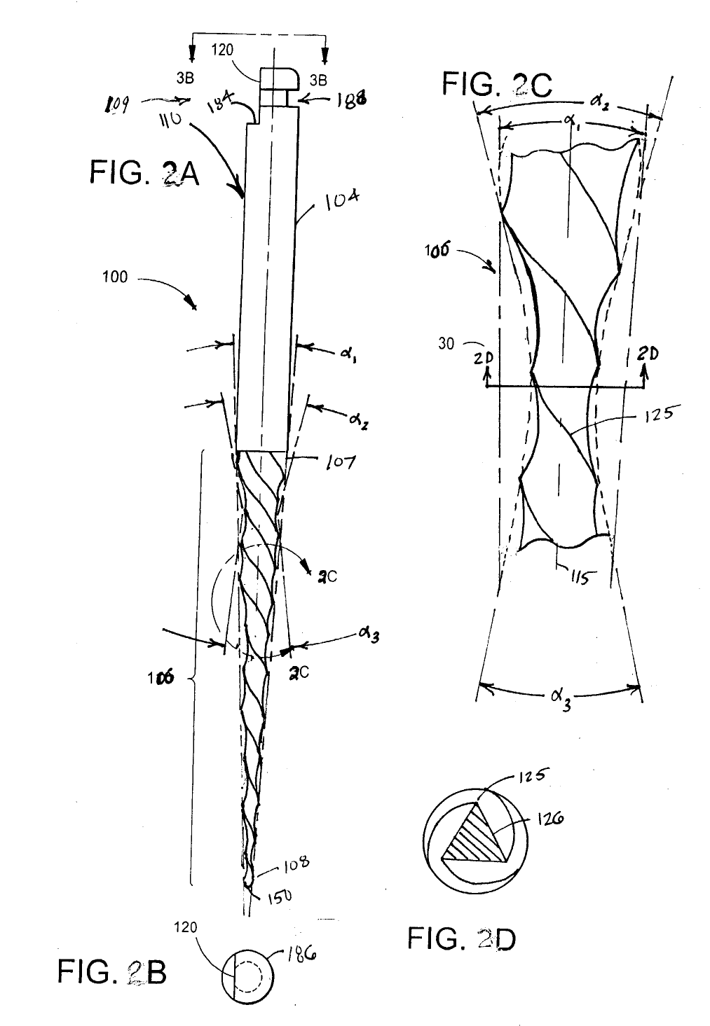

FIGS. 2A-D illustrate one preferred embodiment of a multi-tapered endodontic file having features and advantages of the present invention. The file 100 generally comprises a shaft 110 having a shank portion 104 and an elongated working portion 106. The working portion 106 extends from a proximal end 107 adjacent the base of the shank 104 to a distal end 108 terminating in a tip 150. The shank portion 104 preferably includes a fitting portion 109 for mating with the chuck of a dental handpiece (not shown). The fitting portion 109 includes a generally I-shaped flat side 120 which defines a step 184 and a generally semicircular disk 186 above and adjacent to a generally semi-circular groove 188. Such fitting 109 is typical of those employed in the dental industry for connecting or interfacing a dental tool with dental drill or handpiece.

Alternatively and/or in addition to the fitting portion 109, the shank portion 104 may include a knurled or otherwise treated surface (not shown) or handle to facilitate hand manipulation of the file 100 (see, e.g., FIG. 1). Thus, the instrument 100 may either be used by manipulating the instrument manually in a rotating or reciprocating action, or the instrument may be manipulated by attaching the fitting portion 109 of the instrument to a motorized handpiece for effecting more rapid removal of tissue from the root canal, as desired.

The working portion 106 of the instrument 100 preferably has a length ranging from about 3 mm to about 18 mm. A preferred length is about 16 mm. The outer envelope of the working portion 106 is preferably shaped in accordance with a first taper function from the proximal send 107 to the distal end 108, as shown. In the particular embodiment shown, the first taper function is an elongated cone having a substantially uniform angle of conicity α₁—that is, the rate of taper or cone angle is substantially constant along the working portion 106. A preferred first taper function ranges from a constant taper rate about 0.01 mm/mm to about 0.08 mm/mm. Alternatively, the first taper function may vary over the length of the working portion 108 or follow any other regular or irregular/random function, as desired.

The outer envelope of the working portion 108 is further defined in accordance with a second taper function—different from the first—that preferably varies from a positive taper angle (α₂) to negative taper angle (α₃) along at least a portion of the length of the working portion 108. In the particular embodiment illustrated the second taper function is defined by a generally sinusoidal function having either constant or varying frequency and/or amplitude. More preferably, the second taper function follows a periodic or repeating function, such as a sine function, cosine function or the like. Most preferably, the second taper function follows an underdamped second-order sinusoidal decay function having the following characteristic equation:

f(x)=[Ae^{(-α·x)}·sin(β·x+φ)]

where:

Ae^{(-αx)}=damped amplitude (outer diameter)

β/2π=quasi-frequency

φ=phase angle

One or more cutting edges 125 are preferably formed along the working portion 108 of the instrument 100. These may be formed, for example, by twisting an appropriately shaped multi-tapered prismatic rod (see, e.g., FIGS. 5A-C) and/or by forming helical flutes in a tapered or multi-tapered blank via suitable grinding operations. The cutting edges may have a negative, positive or neutral rake angle, as desired. Alternatively, one or more barbs, notches, abrasive surfaces and/or the like may be used in addition to or instead of cutting edges 125 to provide the desired tissue removal capability of the instrument 100. The tip 150 of the instrument 100 may assume any number of a variety of possible configurations (e.g., chisel, cone, bullet, multi-faceted and/or the like), depending upon the preference of the endodontist and manufacturing conveniences. Again, those skilled in the art will readily appreciate that the particular geometries can be varied without departing from the essential teachings disclosed herein.

Those skilled in the art will appreciate that the particular pattern of exposed cutting edges or other cutting/abrading surfaces can be suitably controlled or modulated by combining multiple taper functions to achieve optimal performance for each particular application. In the particular example illustrated, the size of the cross-section of the working portion 108 alternatingly expands and contracts from the proximal end 107 to the distal end 108 within an envelope defined by the first and second taper functions while remaining essentially concentric with the central axis 115 of the instruments 00.

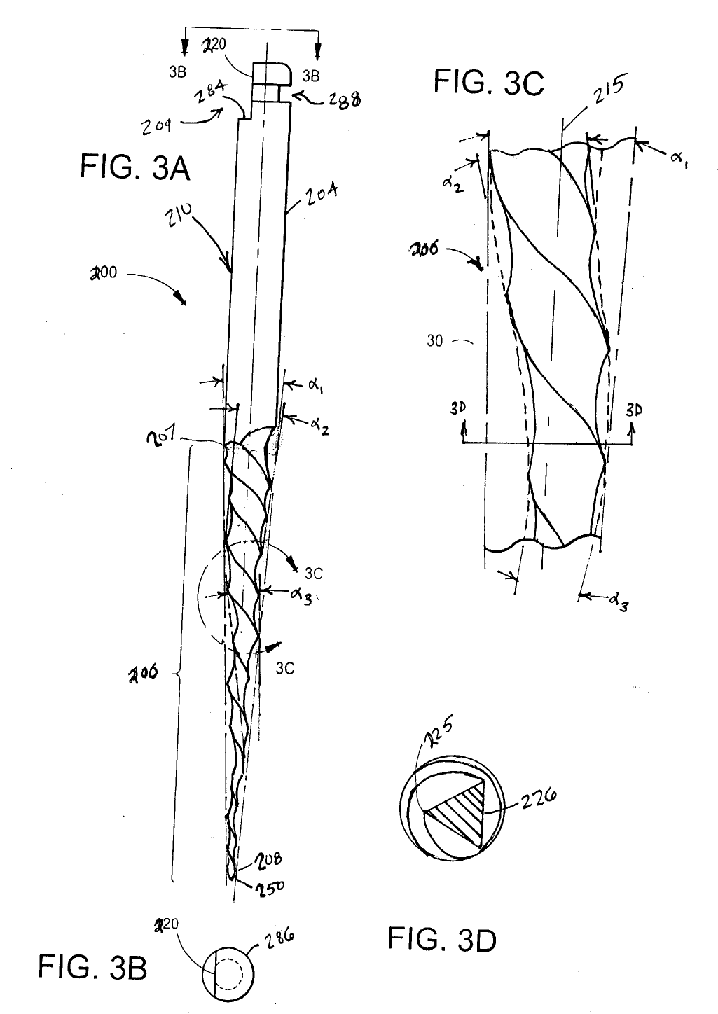

Advantageously, the multi-tapered endodontic file 100 according to the preferred embodiment described above is highly efficacious in cleaning and expanding root canal openings. Multi-tapering causes the particular shape, distribution and/or orientation of cutting edges 125 to be arranged and exposed in such a way as to increase cutting efficiency, reduce friction and torque loading on the instrument 100. In particular, it is believed that multi-tapering decreases the percentage of cutting surfaces in contact with the root canal wall at any given time, thereby increasing localized cutting forces or bearing pressures of each engaged cutting edge portion while simultaneously reducing overall torque loading of the instrument. This increases cutting efficiency of the engaged cutting edge portions. Multi-tapering of the instrument working portion 108 in this manner also increases the flexibility of the instrument in bending without sacrificing overall strength or resistance to torque. This greatly improves the performance of the instrument in curved root canals for a given material and cross-section, allowing larger diameter files to be used in highly curved root canals. In turn, this improves the speed and efficacy of the root canal procedure and reduces the number of endodontic files and other specialized tools required to complete each procedure. Because multi-tapering reduces simultaneous engagement of the instrument cutting edges 125, multi-tapered instruments also have less tendency to “screw in” to the root canal. This adverse tendency can be further reduced by combining additional taper functions that act specifically to counteract the forward advancing forces produced by helical cutting edges (see, e.g., FIGS. 3A-D and the accompanying disclosure).

The shank 110 is preferably (but not necessarily) formed from a rod of nickel titanium alloy, such as SE508 nickel-titanium wire manufactured by Nitinol Devices and Components, Inc. of Fremont, Calif. This is a typical binary nickel-titanium alloy used for endodontic files and comprises about 56% nickel and about 44% titanium by weight. Table 1, below, summarizes certain selected material properties of the SE508 NiTi alloy:

TABLE 1
SE508 MATERIAL PROPERTIES

| | |
|---|---|
| PHYSICAL PROPERTIES | |
| Melting Point | 1310oC |
| Density | 6.5 g/cm³ |
| Electrical Resistivity | 82 μohm-cm |
| Modulus of Elasticity | 75 × 10\hat{ }6 MPa |
| Coefficient of Thermal Expansion | 11 × 10-6/o C |
| MECHANICAL PROPERTIES | |
| Ultimate Tensile Strength (UTS) | 1150 Mpa |
| Total Elongation | 10% |
| SUPERELASTIC PROPERTIES | |
| Loading Plateau Stress @ 3% strain | 450 MPa |
| Superelastic Strain (max) | 8% |
| Permanent Set (after 6% strain) | 0.2% |
| Transformation Temperature (AF) | 5-18o C |
| COMPOSITION | |
| Nickel (nominal) | 55.8 wt. % |
| Titanium (nominal) | 44.2 wt. % |
| Oxygen (max) | 0.05 wt. % (max) |
| Carbon (max) | 0.02 wt. % (max) |

If desired, special heat treatments may be employed and/or trace elements of oxygen (O), nitrogen (N), iron (Fe), aluminum (Al), chromium (Cr), cobalt (Co) vanadium (V), zirconium (Zr) and/or copper (Cu), may be added to achieve desired mechanical properties. See, for example, U.S. Pat. No. 5,843,244 to Pelton, incorporated herein by reference. While nickel-titanium alloys are preferred, the invention disclosed herein is not limited as such, but may be practiced using a wide variety of other suitable alloys, including other super-elastic alloys and conventional medical-grade stainless steel and/or nickel alloys.

The shaft 110 is preferably rolled, ground, extruded or otherwise machined to produce an elongated prismatic structure having a desired multi-tapered geometric shape in cross-section (see, e.g., FIGS. 5A-C). A triangular cross-section is particularly preferred, having three flat facing surfaces (“flats”) 126 and three corners 125 (preferably sharp), as illustrated in FIG. 2D. Of course, those skilled in the art will readily appreciate that a wide variety of other shapes may also be used with efficacy, such as triangular, hexagonal, octagonal, rectangular, or other regular polygon. Certain irregular polygons may also be used with efficacy such as those formed with one or more exposed corners and one or more facing surfaces (flat or otherwise).

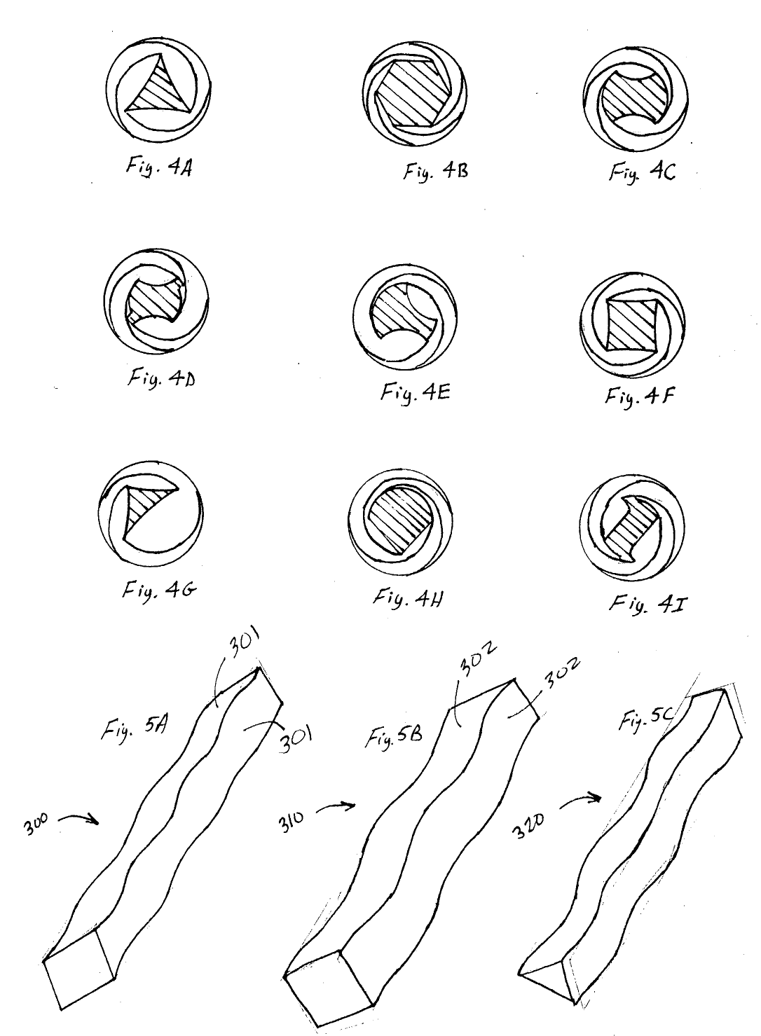

FIGS. 4A-4I illustrate various alternative examples of preferred cross-section shapes that may be used with efficacy. In each of the examples illustrated, it should be understood that the helix angle or angle of twist of the instrument can run either clockwise or counterclockwise (or both) as desired. While a symmetrical sinusoidal decay taper function is illustrated, those skilled in the art will appreciate that a wide variety of multiple taper functions my be used with efficacy, such as linear or non-linear functions, symmetric or asymmetric sine functions, saw-tooth functions, regular or irregular/random functions, and/or the like.

FIGS. 3A-D illustrate an alternative preferred embodiment of a multi-tapered endodontic file having features and advantages of the present invention. The file 200 generally comprises a shaft 210 having a shank portion 204 and an elongated working portion 206. The working portion 206 extends from a proximal end 207 adjacent the base of the shank 204 to a distal end 208 terminating in a tip 250. The shank portion 204 preferably includes a fitting portion 209 for mating with the chuck of a dental handpiece (not shown). The fitting portion 209 includes a generally I-shaped flat side 220 which defines a step 284 and a generally semicircular disk 286 above and adjacent to a generally semi-circular groove 288. Such fitting 209 is typical of those employed in the dental industry for connecting or interfacing a dental tool with dental drill or handpiece.

Alternatively and/or in addition to the fitting portion 209, the shank portion 204 may include a knurled or otherwise treated surface (not shown) or handle to facilitate hand manipulation of the file 200 (see, e.g., FIG. 1). Thus, the instrument 200 may either be used by manipulating the instrument manually in a rotating or reciprocating action, or the instrument may be manipulated by attaching the fitting portion 209 of the instrument to a motorized handpiece for effecting more rapid removal of tissue from the root canal, as desired.

The working portion 206 of the instrument 200 preferably has a length ranging from about 3 mm to about 18 mm. A preferred length is about 16 mm. The outer envelope of the working portion 206 is preferably shaped in accordance with a first taper function from the proximal send 207 to the distal end 208, as shown. In the particular embodiment shown, the first taper function is an elongated cone having a substantially uniform angle of conicity α₁—that is, the rate of taper or cone angle is substantially constant along the working portion 206. A preferred first taper function ranges from a constant taper rate about 0.01 mm/mm to about 0.08 mm/mm. Alternatively, the first taper function may vary over the length of the working portion 208 or may follow any other regular or irregular/random function, as desired.

The outer envelope of the working portion 208 is further defined in accordance with a second taper function—different from the first—that preferably retains a positive taper angle along at least a portion of the length of the working portion 208 from taper angle (α₂) to negative taper angle (α₃), but which effectively modulates the center axis of the cross-section relative to the central axis 215 of the instrument 200.

In the particular embodiment illustrated the second taper function is defined by a generally sinusoidal function having either constant or varying frequency and/or amplitude. More preferably, the second taper function follows a periodic or repeating function, such as a sine function, cosine function or the like. Most preferably, the second taper function follows an underdamped second-order sinusoidal decay function having the following characteristic equation:

f(x)=[Ae^{(-α·x)}^{_{-1.2-}} sin(β·x+φ)]

where:

Ae^{(-αx)}=damped amplitude (outer diameter)

β/2π=quasi-frequency

φ=phase angle

One or more cutting edges 225 are preferably formed along the working portion 208 of the instrument 200. These may be formed, for example, by twisting an appropriately shaped multi-tapered prismatic rod (see, e.g., FIGS. 5A-C) and/or by forming helical flutes in a tapered or multi-tapered blank via suitable grinding operations. The cutting edges may have a negative, positive or neutral rake angle, as desired. Alternatively, one or more barbs, notches, abrasive surfaces and/or the like may be provided in addition to or instead of cutting edges 225 to provide a desired amount of tissue removal capability of the instrument 200. The tip 250 of the instrument 200 may assume any number of a variety of possible configurations (e.g., chisel, cone, bullet, multi-faceted and/or the like), depending upon the preference of the endodontist and manufacturing conveniences. Again, those skilled in the art will readily appreciate that the particular geometries can be varied without departing from the essential teachings disclosed herein.

Those skilled in the art will appreciate that the particular pattern of exposed cutting edges or other cutting/abrading surfaces can be suitably controlled or modulated by combining multiple taper functions to achieve optimal performance for each particular application. In the particular example illustrated, the cross-section of the working portion 208 tapers substantially continuously while simultaneously winding cork-screw-like from the proximal end 207 to the distal end 208 within an envelope defined by the first and second taper functions.

Advantageously, the multi-tapering of the instrument in accordance with the present invention causes the particular shape, distribution and/or orientation of cutting edges 225 to be arranged and exposed in such a way as to increase cutting efficiency, reduce friction and torque loading on the instrument 200. In particular, it is believed that multi-tapering decreases the percentage of cutting surfaces in contact with the root canal wall at any given time, thereby increasing localized cutting forces or bearing pressures of each engaged cutting edge portion while simultaneously reducing overall torque loading of the instrument. This increases cutting efficiency of the engaged cutting edge portions. Multi-tapering of the instrument working portion 208 in this manner also increases the flexibility of the instrument in bending without sacrificing overall strength or resistance to torque. This greatly improves the performance of the instrument in curved root canals for a given material and cross-section.

Because multi-tapering reduces simultaneous engagement of the instrument cutting edges 225, multi-tapered instruments also have less tendency to “screw in” to the root canal. This adverse tendency is further reduced by selecting one or more taper functions that act specifically to counteract the forward advancing forces produced by helical cutting edges. For example, the multi-tapered instrument 200 illustrated in FIGS. 3A-D preferably includes a reverse helical taper function (reverse cork-screw shape) that tends to counteract the forward advancing forces created by the helical cutting edges 225. Thus, if the tip of the instrument 200 were to suddenly bind in the canal, the reverse helical taper would effectively help urge the file out of the canal. Thus, the overall safety of the root canal procedure is greatly improved.

In accordance with one preferred manufacturing technique any variety of multi-tapered instruments may be fabricated by twisting a suitably formed multi-tapered rod such as illustrated in FIGS. 5A-C. For example, FIG. 5A illustrates a tapered rod 300 having a generally square cross section that tapers in and out repeatedly along the length of the rod. A sinusoidal taper function having a determined amplitude and wave length is applied to each face 301 of the rod 300. On adjacent faces 301 the sinusoidal taper functions are in phase. On opposite faces 301 the sinusoidal taper functions are 180° out of phase. In this manner, the cross-section of the rod remains substantially square and essentially concentric throughout its length, but varies in size in accordance with the sinusoidal taper function. Those skilled in the art will readily appreciate that the particular phase, frequency and/or amplitude of each taper function can also be varied or adjusted independently of the other taper functions so as to create various desired interference patterns between the multiple taper functions

FIG. 5B illustrates a tapered rod 310 having a generally square cross section that tapers back and forth repeatedly along the length of the rod. A sinusoidal taper function having a determined amplitude and wave length is applied to each face 302 of the rod 310. On adjacent faces 302 the sinusoidal taper functions are 180° out of phase. On opposite faces 302 the sinusoidal taper functions are in phase. In this manner, the cross-section of the rod remains substantially square and of the same size throughout its length, but moves back and forth and left to right in a cork-screw fashion relative to the centerline of the rod in accordance with the sinusoidal taper function. Those skilled in the art will readily appreciate that the particular phase, frequency and/or amplitude of each taper function can also be varied or adjusted independently of the other taper functions so as to create various desired interference patterns between the multiple taper functions.

FIG. 5C illustrates a tapered rod 320 having a generally the same taper functions as the rod 310 in FIG. 5B, except having a generally triangular cross section with three flats and preferably three sharp corners, as illustrated. Those skilled in the art will readily appreciate that a wide variety of alternative taper functions and cross-sections having various constant or non-constant phase angles, wave lengths and frequencies may be used and combined together to produce any variety of desired performance characteristics. Useful taper functions may include, without limitation, straight linear taper functions, horn-shaped or flared taper functions, exponential or lognormal taper functions, repeating and/or non-repeating taper functions, sinusoidal taper functions, saw-tooth taper functions, random taper functions, and the like.

Alternatively, or in addition, any variety of multi-tapered instruments may be fabricated by grinding operations using a 3-axis or, more preferably, a 6-axis computer-controlled grinding machine programmed with a suitable instruction set. In this manner, any variety of complex instrument designs having multiple superimposed taper functions may be programmed and useful instruments may be readily fabricated therefrom. Each tapering and/or fluting operation may be performed as a separate manufacturing step, or, alternatively, multiple tapers and/or fluting may be formed simultaneously. Grinding operations are particular preferred for producing multi-tapered instruments with sharp, positive- or neutral-rake-angle cutting edges. Grinding operations are also particularly preferred for refining and testing commercial prototypes since various multiple-taper designs can be readily programmed, manufactured and tested with relative ease. Those skilled in the art will readily appreciate that various multi-tapered file designs can also be tested, adjusted and optimized according to specific tasks, functions, root canal types and/or user-preferences.

The concepts and teachings of the present invention are particularly applicable to nickel-titanium alloys and endodontic instruments (files, reamers, obturators, drill bits and the like) fabricated therefrom. However, the invention disclosed herein is not limited specifically to endodontic instruments fabricated from NiTi alloys, but may be practiced with a variety of dental and other medical instruments using any one of a number of other suitable medical-grade alloys. Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. An endodontic instrument for cleaning and extirpating a root canal, comprising an elongated shaft having a working portion having one or more tissue-removing edges, points and/or surfaces defined thereon, said working portion being tapered along its length in accordance with a first predetermined taper function, said working portion being further tapered in accordance with second taper function different from said first taper function, whereby a desired interference pattern of said tissue-removing edges, points and/or surfaces is achieved.

2. The endodontic instrument of claim 1 wherein said elongated shaft comprises a generally prismatic rod of material having a desired cross-section shape defined by three or more sides and substantially sharp corners interposed therebetween.

3. The endodontic instrument of claim 2 wherein said elongated shaft is formed by shaping a first side of said rod in accordance with a predetermined taper function, shaping a second side of said rod in accordance with a predetermined second taper function different than said first taper function, and twisting said rod in a manner to cause said sides and said corners of said rod to assume a generally helical or spiraling shape having one or more exposed tissue-removing edges, points and/or surfaces defined thereon.

4. The endodontic instrument of claim 1 wherein said elongated shaft comprises a generally cylindrical rod of material having a desired cross-section shape defined by grinding one or more flutes or flats therein.

5. The endodontic instrument of claim 1 wherein said first or second predetermined taper function comprises a linear taper function having a substantially constant taper rate of about 0.01 mm/mm to about 0.08 mm/mm.

6. The endodontic instrument of claim 1 wherein said first or second predetermined taper function comprises an accelerating or decelerating taper function having a taper rate varying between about 0.01 mm/mm to about 0.08 mm/mm.

7. The endodontic instrument of claim 1 wherein said first or second predetermined taper function comprises a regular, irregular or random function varying over the length of said working portion.

8. The endodontic instrument of claim 1 wherein said first or second predetermined taper function comprises an oscillating or sinusoidal function.

9. The endodontic instrument of claim 8 wherein said sinusoidal or oscillating function has a substantially constant frequency and amplitude over the length of said working portion.

10. The endodontic instrument of claim 9 wherein said sinusoidal or oscillating function has a substantially varying frequency and/or amplitude over the length of said working portion.

11. The endodontic instrument of claim 1 wherein said working portion is tapered along a first part of its length in accoreace with a first taper function havcing a substantially constant or unidirectionally varying taper rate and is tapered along a second part of its length in accordance with a second taper function that varies from a positive taper angle (α2) to negative taper angle (α3), and wherein at least a portion of said first part and said second part of said working portion overlap.

12. The endodontic instrument of claim 1 wherein said first and/or second taper function comprises an underdamped second-order sinusoidal decay function having the following characteristic equation:
f(x)=[Ae^{(-α·x)}·sin(β·x+φ)]
where:
Ae^{(-αx)}=damped amplitude
β/2π=quasi-frequency
φ=phase angle.

13. The endodontic instrument of claim 1 wherein said working portion comprises one or more cutting edges arranged in a spiral or helical pattern and wherein said first or second taper function is selected to substantially counteract against a forward advancing force produced by rotating said endodontic instrument in a root canal.

14. A multi-tapered endodontic file formed from a shaft of material having a generally twisted or fluted prismatic shape defined by three or more side surfaces and three or more interposed corners, said shaft including a working portion having one or more tissue-removing cutting edges, said working portion being tapered along its length in accordance with a first predetermined taper function and a second predetermined taper function different from said first taper function.

15. The multi-tapered endodontic instrument of claim 14 wherein said elongated shaft comprises a generally prismatic rod of material having a desired cross-section shape defined by three or more sides and substantially sharp corners interposed therebetween.

16. The multi-tapered endodontic instrument of claim 15 wherein said elongated shaft is formed by shaping a first side of said rod in accordance with a predetermined taper function, shaping a second side of said rod in accordance with a predetermined second taper function different than said first taper function, and twisting said rod in a manner to cause said sides and said corners of said rod to assume a generally helical or spiraling shape having one or more exposed tissue-removing edges, points and/or surfaces defined thereon.

17. The multi-tapered endodontic instrument of claim 14 wherein said elongated shaft comprises a generally cylindrical rod of material having a desired cross-section shape defined by grinding one or more flutes or flats therein.

18. The multi-tapered endodontic instrument of claim 14 wherein said first or second predetermined taper function comprises a linear taper function having a substantially constant taper rate of about 0.01 mm/mm to about 0.08 mm/mm.

19. The multi-tapered endodontic instrument of claim 14 wherein said first or second predetermined taper function comprises an accelerating or decelerating taper function having a taper rate varying between about 0.01 mm/mm to about 0.08 mm/mm.

20. The multi-tapered endodontic instrument of claim 14 wherein said first or second predetermined taper function comprises a regular, irregular or random function varying over the length of said working portion.

21. The multi-tapered endodontic instrument of claim 14 wherein said first or second predetermined taper function comprises an oscillating or sinusoidal function.

22. The multi-tapered endodontic instrument of claim 21 wherein said sinusoidal or oscillating function has a substantially constant frequency and amplitude over the length of said working portion.

23. The multi-tapered endodontic instrument of claim 22 wherein said sinusoidal or oscillating function has a substantially varying frequency and/or amplitude over the length of said working portion.

24. The multi-tapered endodontic instrument of claim 14 wherein said working portion is tapered along a first part of its length in accoreace with a first taper function having a substantially constant or unidirectionally varying taper rate and is tapered along a second part of its length in accordance with a second taper function that varies from a positive taper angle (α2) to negative taper angle (α3), and wherein at least a portion of said first part and said second part of said working portion overlap.

25. The endodontic instrument of claim 14 wherein said first and/or second taper function comprises an underdamped second-order sinusoidal decay function having the following characteristic equation:
f(x)=[Ae^{(-α·x)}·sin(β·x+φ)]
where:
Ae^{(-αx)}=damped amplitude
β/2π=quasi-frequency
φ=phase angle

26. The endodontic instrument of claim 14 wherein said working portion comprises one or more cutting edges arranged in a spiral or helical pattern and wherein said first or second taper function is selected to substantially counteract against a forward advancing force produced by rotating said endodontic instrument in a root canal.

27. A multi-tapered endodontic instrument for cleaning and extirpating a root canal, siad instrument comprising an elongated shaft having a working portion having one or more tissue-removing edges, points and/or other tissue abrading surfaces thereon; said working portion being tapered along its length in accordance with a first predetermined taper function and with a second predtermeind taper function different from said first taper function, whereby a desired interference pattern of tissue-removing edges, points and/or other surfaces is achieved.

28. The multi-tapered endodontic instrument of claim 27 wherein said elongated shaft comprises a generally prismatic rod of material having a desired cross-section shape defined by three or more sides and substantially sharp corners interposed therebetween.

29. The multi-tapered endodontic instrument of claim 28 wherein said elongated shaft is formed by shaping a first side of said rod in accordance with a predetermined taper function, shaping a second side of said rod in accordance with a predetermined second taper function different than said first taper function, and twisting said rod in a manner to cause said sides and said corners of said rod to assume a generally helical or spiraling shape having one or more exposed tissue-removing edges, points and/or surfaces defined thereon.

30. The multi-tapered endodontic instrument of claim 27 wherein said elongated shaft comprises a generally cylindrical rod of material having a desired cross-section shape defined by grinding one or more flutes or flats therein.

31. The multi-tapered endodontic instrument of claim 27 wherein said first or second predetermined taper function comprises a regular, irregular or random function varying over the length of said working portion.

32. The multi-tapered endodontic instrument of claim 27 wherein said first or second predetermined taper function comprises an oscillating or sinusoidal function.

33. The multi-tapered endodontic instrument of claim 32 wherein said sinusoidal or oscillating function has a substantially constant frequency and amplitude over the length of said working portion.

34. The multi-tapered endodontic instrument of claim 33 wherein said sinusoidal or oscillating function has a substantially varying frequency and/or amplitude over the length of said working portion.

35. The multi-tapered endodontic instrument of claim 27 wherein said working portion is tapered along a first part of its length in accoreace with a first taper function having a substantially constant or unidirectionally varying taper rate and is tapered along a second part of its length in accordance with a second taper function that varies from a positive taper angle (α2) to negative taper angle (α3), and wherein at least a portion of said first part and said second part of said working portion overlap.

36. The endodontic instrument of claim 27 wherein said working portion comprises one or more cutting edges arranged in a spiral or helical pattern and wherein said first or second taper function is selected to substantially counteract against a forward advancing force produced by rotating said endodontic instrument in a root canal.

37. A method of manufacturing a multi-tapered endodontic instrument comprising the following steps: forming an elongated generally prismatic rod of material having a desired cross-section shape defined by three or more sides and substantially sharp corners interposed therebetween; shaping a first side of said rod in accordance with a predetermined taper function; shaping a second side of said rod in accordance with a predtermined second taper function different than said first taper function; and twisting said rod in a manner to cause said sides and said corners of said rod to assume a generally helical or spiraling shape.

38. The method claim 37 wherein said elongated wherein said first or second predetermined taper function comprises a linear taper function having a substantially constant taper rate of about 0.01 mm/mm to about 0.08 mm/mm.

39. The method of claim 37 wherein said first or second predetermined taper function comprises an accelerating or decelerating taper function having a taper rate varying between about 0.01 mm/mm to about 0.08 mm/mm.

40. The method of claim 37 wherein said first or second predetermined taper function comprises a regular, irregular or random function varying over the length of said working portion.

41. The method of claim 37 wherein said first or second predetermined taper function comprises an oscillating or sinusoidal function.

42. The method of claim 41 wherein said sinusoidal or oscillating function has a substantially constant frequency and amplitude over the length of said working portion.

43. The method of claim 42 wherein said sinusoidal or oscillating function has a substantially varying frequency and/or amplitude over the length of said working portion.

44. The method of claim 37 wherein said first and/or second taper function comprises an underdamped second-order sinusoidal decay function having the following characteristic equation:
where:
Ae^{(-αx)}=damped amplitude
β/2π=quasi-frequency
φ=phase angle

45. The method of claim 37 wherein said shaping step is performed using a programable 3-axis or 6-axis computer-controlled grinding machine.
